(19) United States
(12) Patent Application Publication
(10) Pub. No.: US 2026/0209059 A1
(43) Pub. Date: Jul. 23, 2026

(54) Calcination Apparatus and Process

(71) Applicant: Rio Tinto Alcan International Limited, Montreal (CA)

(72) Inventors: Michaël Reid, Quebec (CA); Véronique Savard, Quebec (CA); Stephen Tysoe, Singleton (AU)

(21) Appl. No.: 19/140,546

(22) PCT Filed: Dec. 22, 2023
(86) PCT No.: PCT/IB2023/063167

§ 371 Date: Jun. 18, 2025

(30) Foreign Application Priority Data
Dec. 23, 2022 (AU) 2022904018

(51) Int. Cl. C01F 7/444; B01J 6/00; C01F 7/445

(52) U.S. Cl. CPC C01F 7/444; B01J 6/004; C01F 7/445

(57) ABSTRACT

A process for calcining aluminium trihydrate (Al₂O₃·3H₂O) to form alumina (Al₂O₃) replaces at least a part of a natural gas energy source for generating heat for use in a calciner with an electrical energy source. The process may comprise using at least one electrically-heated fluidized bed reactor for calcining aluminium trihydrate.

### TECHNICAL FIELD

The present invention relates to a process and an apparatus to calcine aluminium hydroxide to form alumina.

### BACKGROUND ART

The production of alumina (Al₂O₃) in an alumina production plant, such as a Bayer process plant, includes calcining aluminium hydroxide (Al₂O₃·3H₂O—also termed alumina hydroxide, aluminium trihydrate and hydrated alumina) to remove water.

The calcination of aluminium hydroxide is a thermal decomposition chemical reaction, which proceeds endothermically according to the following reaction:

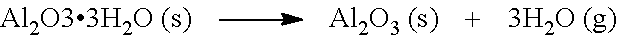

A typical calciner used to produce alumina has a reaction chamber that combusts natural gas and oxygen to form heat and flue gas that comprises N₂, CO₂ and steam. The heat generated in the reaction chamber by combustion of natural gas and oxygen is used to drive water off aluminium hydroxide to form alumina.

The above description is not to be taken as an admission of the common general knowledge in Australia or elsewhere.

### SUMMARY OF THE INVENTION

The applicant operates natural gas-fired calciners to dehydrate aluminium hydroxide in the form of the mineral gibbsite (Al₂O₃·3H₂O) into alumina (Al₂O₃).

The dehydration process may involve the conversion of gibbsite into aluminum oxyhydroxide (boehmite), which in turn is converted into alumina.

The present invention provides an opportunity to reduce greenhouse gas emissions associated with using natural gas as an energy source for calcination by using electrical heating derived from renewable energy either to partially or fully replace natural gas as an energy source for calcining aluminium hydroxide.

The present invention also takes advantage of the following points.
at least 35% of the energy that is required to calcine aluminium trihydrate into alumina can be absorbed at or below 400° C.
at least 80% of the energy that is required to calcine aluminium trihydrate into alumina can be absorbed at or below 700° C.

In broad terms, the invention provides a process for calcining aluminium trihydrate (Al₂O₃·3H₂O), such as gibbsite, to form alumina (Al₂O₃), the process comprising: (a) supplying aluminium trihydrate particles to an electrically heated 1^{st} reactor and heating aluminium trihydrate particles to temperatures up to at least 280° C., preferably up to at least 320° C., more preferably up to at least 350° C., and no greater than 400° C. and calcining at least a major part of the aluminium trihydrate (Al(OH)₃) to aluminum oxyhydroxide (γ-AlOOH or AlO(OH)) in the 1^{st} reactor; and (b) supplying aluminium oxyhydroxide particles from the 1^{st} reactor to a 2^{nd} reactor and heating aluminium oxyhydroxide particles and calcining aluminium oxyhydroxide to alumina.

The term “major part” refers to at least 50%, suitably at least 60%, more suitably at least 70%, of the number of aluminium trihydrate particles being calcined to aluminium oxyhydroxide.

The term “reactor” is understood herein to mean a container or apparatus in which substances can react, for example chemically.

In some embodiments, the process may involve heating aluminium trihydrate particles to temperatures up to at least 350° C. in the 1^{st} reactor.

In some embodiments, the process may involve heating aluminium trihydrate particles to temperatures between 280° C. and 400° C. in the 1^{st} reactor.

In some embodiments, the process may involve providing at least 35% of the energy that is required to calcine aluminium trihydrate into alumina to the 1^{st} reactor at temperatures of up to 350° C.

In other embodiments, the process may involve providing at least 80% of the energy that is required to calcine aluminium trihydrate into alumina to the 1^{st} reactor at temperatures up to 350° C. and to the 2^{nd} reactor at temperatures up to 500° C.-800° C.

The energy required to convert aluminum oxyhydroxide into alumina in the 2^{nd} reactor may be obtained from any suitable source, such as natural gas, renewable energy, natural gas or hydrogen.

The process may involve heating aluminum oxyhydroxide particles at temperatures up to 720° C., suitably up to 600° C., in the 2^{nd} reactor and calcining aluminum oxyhydroxide in the 2^{nd} reactor.

The process may involve heating aluminum oxyhydroxide particles at temperatures up to 760° C., suitably up to 700° C. in the 2^{nd} reactor and calcining aluminum oxyhydroxide in the 2^{nd} reactor.

The process may involve providing 20-50% of the energy that is required to calcine aluminium trihydrate into alumina at temperatures up to 400° C. in the 1^{st} reactor.

The process may involve providing 40-90%, suitably 70-90% of the energy that is required to calcine aluminium trihydrate into alumina at temperatures up to 760° C. in the 2^{nd} reactor.

The process may result in an alumina Loss on Ignition (LOI) from the 2^{nd} reactor of less than 6%, suitably an LOI of around 4%.

The process may involve providing the remainder of the energy that is required to calcine aluminium trihydrate into alumina in a 3^{rd} reactor after the 2^{nd} reactor, typically to obtain a target product quality, such as desirable alumina surface properties.

The electricity used to power the electrically-heated 1^{st} reactor may be generated from any suitable source, such as from renewable sources, such as wind, solar, hydro or geothermal. By using renewable sources, greenhouse gas emissions can be further reduced.

The 1^{st} reactor may be a fluidised bed reactor.

A “fluidised bed reactor” is understood herein to mean a type of reactor that involves a fluid being passed through a solid granular material at sufficient velocity to suspend the solid material and cause it to behave as though it was a fluid.

Advantages of using a fluidised bed reactor include a higher efficiency in heat exchange, compared to fixed beds, and better temperature control, due to the turbulent gas flow and rapid circulation.

The 1^{st} reactor may be a 1^{st} fluidised bed reactor that is electrically heated via sheathed electrical elements within the reactor in direct contact with the aluminium trihydrate.

The 1^{st} reactor may be a 1^{st} fluidised bed reactor that is electrically heated by coil or induction elements.

The 1^{st} fluidised bed reactor may be configured to facilitate direct contact between aluminium trihydrate particles supplied to the reactors and electrical heating elements in the reactors.

The electrical elements in the 1^{st} fluidised bed reactor may operate at any suitable voltage.

For example, the voltage may be in a range of 200-600V, suitably at a higher end of the range.

The 2^{nd} reactor may be electrically-heated.

The electricity used to power the electrically-heated 2^{nd} reactor may be generated from any suitable source, such as from renewable sources, such as wind, solar, hydro or geothermal. By using renewable sources, greenhouse gas emissions can be further reduced. However, it is also envisaged that the 2^{nd} reactor may be heated by any other means for example by combustion of fuel such as natural gas or hydrogen.

The 2^{nd} reactor may be a 2^{nd} fluidised bed reactor.

The 2^{nd} reactor may be a furnace.

The 2^{nd} reactor may be a 2^{nd} fluidised bed reactor that is electrically heated via sheathed electrical elements within the reactor in direct contact with the aluminium trihydrate.

The electrical elements in the 2^{nd} fluidised bed reactor may operate at any suitable voltage.

For example, the voltage may be in a range of 400-600V, suitably at a higher end of the range.

The 1^{st} fluidised bed reactor and the 2^{nd} fluidised bed reactor may be configured to facilitate direct contact between aluminium trihydrate particles supplied to the reactors and electrical heating elements in the reactors.

The process may involve heating aluminum oxyhydroxide particles from the 1^{st} reactor, such as by heat transfer from hot offgas from the process, and supplying heated aluminum oxyhydroxide particles to the 2^{nd} reactor and heating aluminum oxyhydroxide particles and calcining aluminum oxyhydroxide in the 2^{nd} reactor.

The process may involve transferring calcined aluminum oxyhydroxide particles in the 2^{nd} reactor to a 3^{rd} reactor and heating calcined aluminum oxyhydroxide particles and calcining aluminum oxyhydroxide to alumina in the 3^{rd} reactor.

The 3^{rd} reactor may be electrically-heated.

The electricity used to power the electrically-heated 3^{rd} reactor may be generated by renewable sources, such as wind, solar, hydro or geothermal. However, it is also envisaged that the 3^{rd} reactor may be heated by any other means for example by combustion of fuel such as natural gas or hydrogen.

The 3^{rd} reactor may be a fluidised bed reactor.

The 3^{rd} reactor may be a furnace

The 3^{rd} reactor may be a fluidised bed reactor that is electrically heated via sheathed electrical elements within the reactor in direct contact with the aluminium trihydrate has electrical heating elements within the reactor.

The 1^{st} reactor may be a fluidised bed reactor that is electrically heated by coil or induction elements.

The process may involve heating calcined aluminum oxyhydroxide particles to temperatures up to 1000° C. in the 3^{rd} reactor.

The process may involve providing 90-100% of the energy that is required to calcine aluminium trihydrate into alumina at temperatures up to 1000° C. in the 3^{rd} reactor.

The process may result in an alumina Loss on Ignition (LOI) from the 3^{rd} reactor of less than 1%, suitably an LOI of less than 0.8%.

The process may involve drying feed aluminium trihydrate particles by heat transfer from hot offgas from the process, separating dried feed aluminium trihydrate particles from the offgas stream, and supplying the dried feed aluminium trihydrate particles to the 1^{st} reactor.

The invention also provides an apparatus for calcining aluminium hydroxide (Al₂O₃·3H₂O) to form alumina (Al₂O₃), the apparatus comprising: (a) a 1^{st} reactor that is configured to heat aluminium trihydrate particles to temperatures up to 400° C. and calcining at least a major part of the aluminium trihydrate to aluminum oxyhydroxide (γ-AlOOH or AlO(OH)) in the 1^{st} reactor; and (b) a 2^{nd} reactor for heating and calcining aluminum oxyhydroxide particles from the 1^{st} reactor to alumina.

The 1^{st} reactor may be electrically-heated. The electricity used to power the electrically-heated 1^{st} reactor may be generated by renewable sources, such as wind, solar, hydro or geothermal. By using renewable sources, greenhouse gas emissions can be further reduced.

The 1^{st} reactor may be a 1^{st} fluidised bed reactor.

The 1^{st} reactor may be a 1^{st} fluidised bed reactor that has electrical heating elements within the reactor.

The electrical heating elements of the 1^{st} fluidised reactor may comprise (a) metal tubes, and (b) electric heating elements within the tubes.

The 2^{nd} reactor may be electrically-heated. The electricity used to power the electrically-heated 2^{nd} reactor may be generated by renewable sources, such as wind, solar, hydro or geothermal. By using renewable sources, greenhouse gas emissions can be further reduced. However, it is also envisaged that the 2^{nd} reactor may be heated by any other means for example by combustion of fuel such as natural gas or hydrogen.

The 2^{nd} reactor may be a 2^{nd} fluidised bed reactor.

The 2^{nd} reactor may be a 2^{nd} fluidised bed reactor that has electrical heating elements within the reactor.

The electrical heating elements of the 2^{nd} fluidised bed reactor may be any suitable elements.

The electrical heating elements of the 2^{nd} fluidised bed reactor may comprise electric heating elements within a heat conductive housing.

The electrical heating elements of the 2^{nd} fluidised bed reactor may comprise (a) metal tubes, and (b) electric heating elements within the tubes.

The 1^{st} and 2^{nd} reactors may be connected in a counter-current configuration. In this configuration, a flow of gas is counter to a flow of aluminium trihydrate particles. For example, a flue gas exiting the 2^{nd} reactor is directed towards the 1^{st} reactor while a flow of aluminium trihydrate particles is directed from the 1^{st} reactor towards the 2^{nd} reactor.

### BRIEF DESCRIPTION OF THE DRAWINGS

Embodiments of the present invention are described further with reference to the accompanying non-limiting Figures of which:

FIG. 1 illustrates an example of a conventional calcination plant;

FIG. 2 illustrates a schematic version of FIG. 1;

FIG. 3 illustrates in schematic form an embodiment of an apparatus for calcining aluminium hydroxide in accordance with the invention;

FIG. 4 illustrates in schematic form another, although not the only other, embodiment of an apparatus for calcining aluminium hydroxide in accordance with the invention;

FIG. 5 illustrates in schematic form another, although not the only other, embodiment of an apparatus for calcining aluminium hydroxide in accordance with the invention;

FIG. 6 illustrates a horizontal sectional view of a bottom half of a fluidised bed reactor that is used in an embodiment of a calcination plant in accordance with the invention;

FIG. 7 illustrates a plan view of a cartridge comprising a bundle of electric heating devices that is used in the FIG. 6 fluidised bed reactor that, as noted above, is used in an embodiment of a calcination plant in accordance with the invention; and

FIG. 8 illustrates in schematic form a counter-current configuration of two fluidised bed reactors used in an embodiment of a calcination plant in accordance with the invention.

### DESCRIPTION OF EMBODIMENTS

The following description is in the context of calcining aluminium trihydrate, such as the mineral gibbsite, to form alumina.

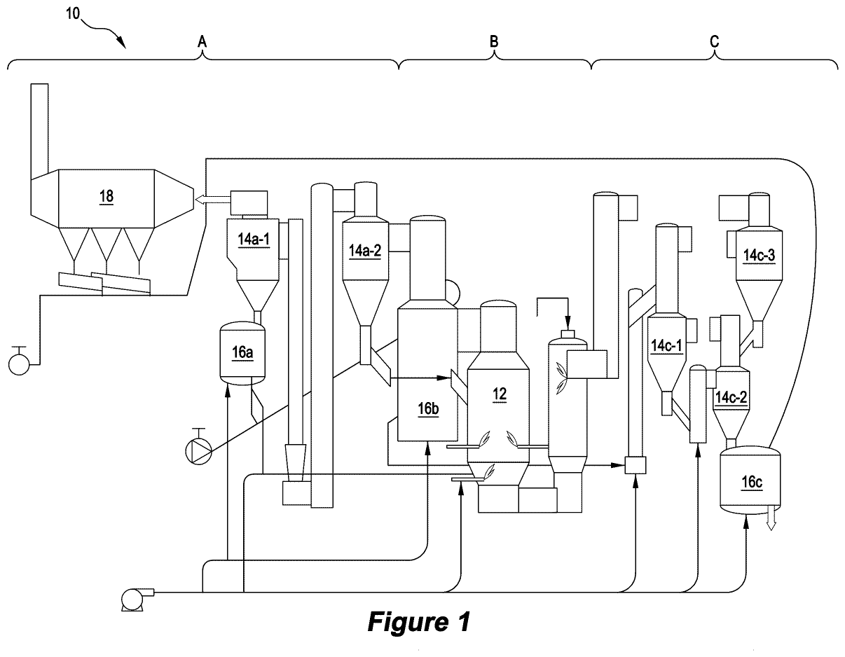

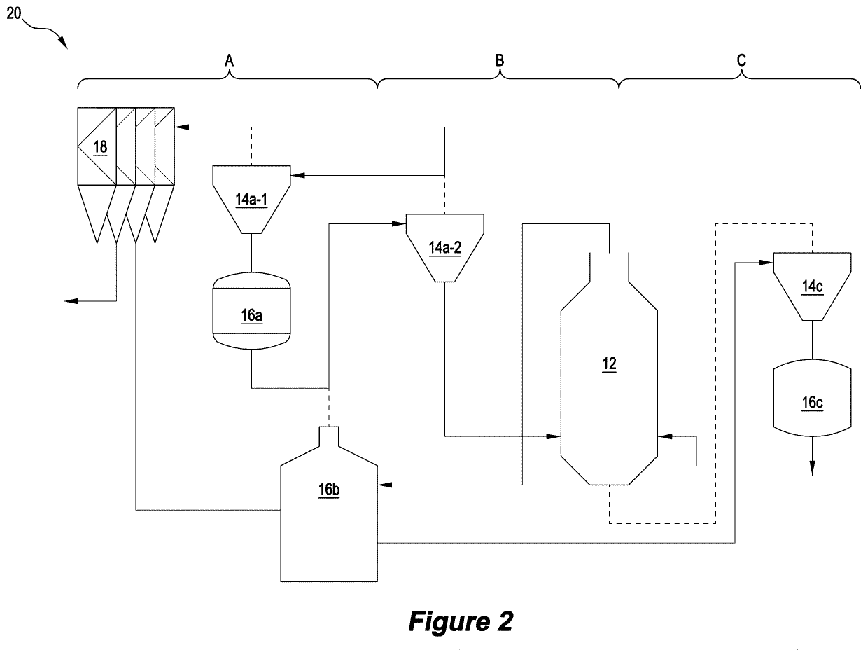

FIGS. 1 and 2 show an example of a conventional calcination plant 10.

The plant 10 comprises a plurality of zones, namely: a drying zone A, a heating zone B, and a cooling zone C.

In the drying zone A, aluminium trihydrate (gibbsite) particles are fed into the plant 10 via an inlet and are heated by direct contact with combustion gases at low temperatures between 100° C. and 340° C. to remove unbound and physically bound water. The dehydrated aluminium trihydrate particles are then fed via gravity and an inlet into the heating zone B.

In the heating zone B, dehydrated aluminium trihydrate particles are heated to between 900° C. and 1100° C. to remove chemically bound water to produce alumina particles. The alumina particles are then fed into the cooling zone C.

In the cooling zone C, the alumina particles are cooled. The heat may be recuperated, using heat exchangers, and used in other areas of the plant 10.

Central to the operation of the plant 10 is a reactor in the form of a natural gas fired furnace 12 that combusts natural gas or other fossil fuels to produce heat. The heat is used to remove chemically bound water in the aluminium trihydrate particles in the heating stage B. The temperature produced in the furnace 12 is between 900° C. and 1100° C.

The plant 10 comprises a plurality of cyclone separators 14a-1, 14a-2 and cyclone separators 14c-1, 14c-2, 14c-3 in the drying zone A and the cooling zone C, respectively.

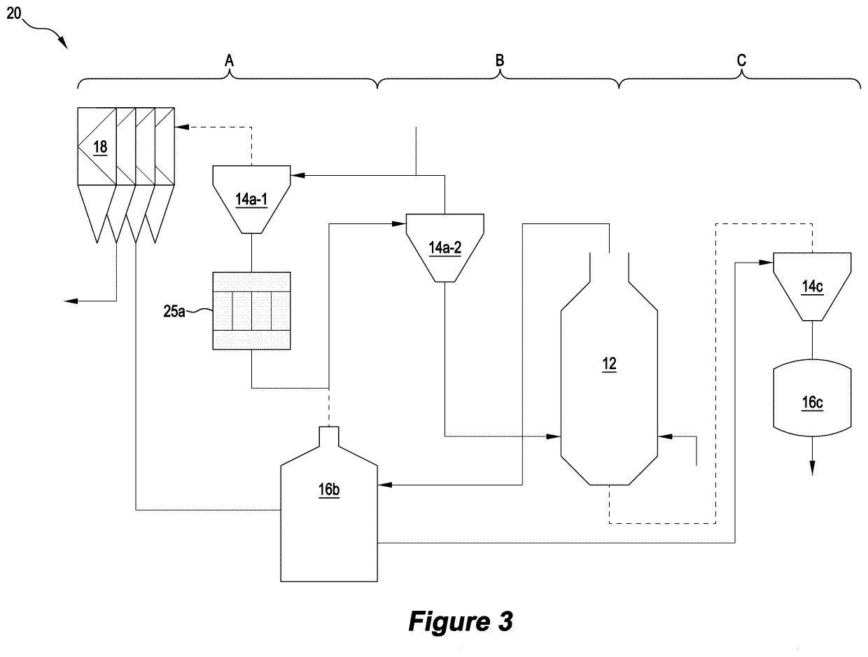

The cyclone separators 14c-1, 14c-2, 14c-3 in FIG. 1 are collectively referred to as 14c in FIG. 2. This is also the case in FIGS. 3-5, as described below.

In the case of cyclone 14a-1, the purpose of the cyclone is to facilitate (a) heat transfer between flue gases and feed aluminium trihydrate particles and partially calcined aluminium trihydrate particles and (b) separation of particles from the flue gases.

In the case of cyclone 14a-2, the purpose of the cyclone is to facilitate (a) heat transfer between flue gases and partially calcined aluminium trihydrate particles and (b) separation of particles from the flue gases.

In the case of cyclones 14c-1, 14c-2, 14c-3, the purpose of the cyclones is to facilitate (a) heat transfer between air and alumina particles and (b) separation of particles from the flue gases, with the heat transfer cooling the alumina particles and heating the air.

Each cyclone separator comprises a conical shaped housing having a tangential side inlet, an upper outlet and an opposing lower outlet. A vortex is generated within the conical shaped housing which entrains particles that enter via the inlet. The majority of the particles exit each cyclone separator via a lower outlet while a small amount, mostly the lighter particles, are carried upwards by the vortex and exit cyclone separator via an upper outlet into an electrostatic precipitator 18 see FIG. 2.

The plant 10 also comprises a plurality of holding vessels 16a, 16b, 16c to control the residence time for particles in each zone.

The present invention provides an opportunity to reduce greenhouse gas emissions associated with using natural gas or other fossil fuels as an energy source for calcination by using electrical heating derived from renewable energy either to partially or fully replace natural gas as an energy source for calcining aluminium hydroxide.

The present invention takes advantage of the following point—35% of the energy that is required to calcine aluminium trihydrate into alumina can be absorbed below 400° C., suitably 350° C.

The present invention takes advantage of the above point, for example in the FIG. 3 embodiment, by calcining at least a major part of feed aluminium trihydrate particles at lower temperatures than in the FIGS. 1 and 2 conventional calcination plant. This in turn provides an opportunity to use electricity, for example, generated from renewable energy, as a replacement of at least a part of the natural gas used to generate energy in the FIGS. 1 and 2 plant.

FIG. 3 shows an embodiment of a calcination plant 20 in accordance with the invention.

The calcination plant 20 in FIG. 3 differs from the conventional plant 10 shown in FIGS. 1 and 2 in that the holding vessel 16a in FIGS. 1 and 2 is substituted with an electrically-heated 1^{st} fluidised bed reactor 25a, which typically operates at around 600V. The remaining equipment of the plant 20 is the same as that of the FIGS. 1 and 2 plant, with the same reference numbers in FIGS. 1 and 2 being used in FIG. 3.

The aluminum oxyhydroxide particles are transferred from the 1^{st} fluidised bed reactor 25a to the cyclone separator 14a-2.

In the 1^{st} fluidised bed reactor 25a, aluminium trihydrate particles from the cyclone separator 14a-1 are heated to temperatures between 320° C. and 400° C., suitably around 350° C. This results in partially calcining at least a major part, typically at least 50%, of the aluminium trihydrate to aluminum oxyhydroxide (γ-AlOOH or AlO(OH)).

Between 20-50% of the energy that is required to calcine aluminium trihydrate into alumina is provided by heating aluminium trihydrate particles to temperatures between 320° C. and 400° C. in the 1^{st} fluidised bed reactor 25a.

The incorporation of the electrically-heated 1^{st} fluidised bed reactor 25a in effect substitutes 20-50% of the energy derived from natural gas which is required for plant 10 shown in FIGS. 1 and 2, which results in a significant reduction in associated greenhouse gas emissions.

The peak power demand of the electrically-heated 1^{st} fluidised bed reactor 25a in plant 20 in FIG. 3 is about 35% of the total energy required for calcination to the target surface area.

The remaining energy that is required to form alumina is provided by the furnace 12.

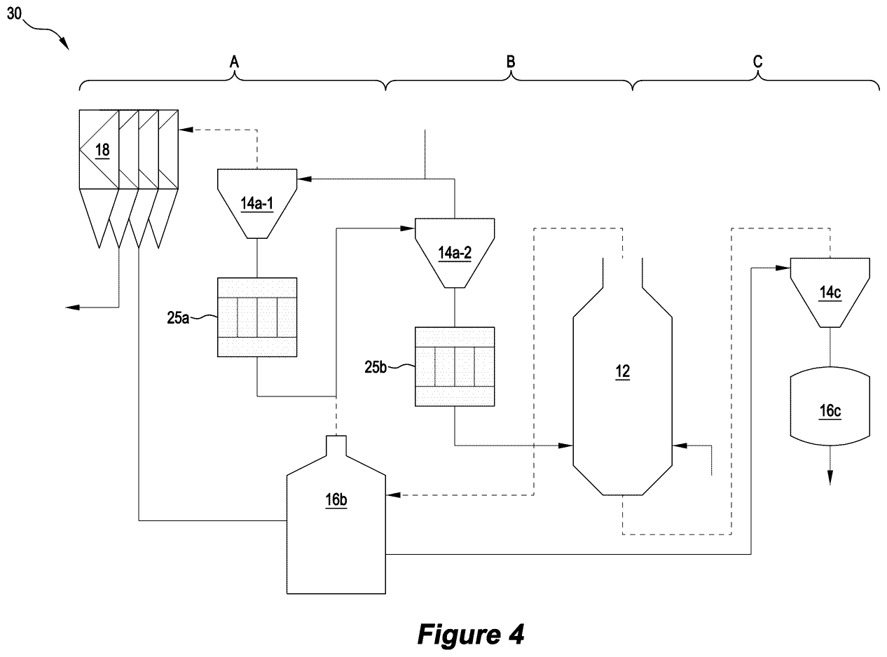

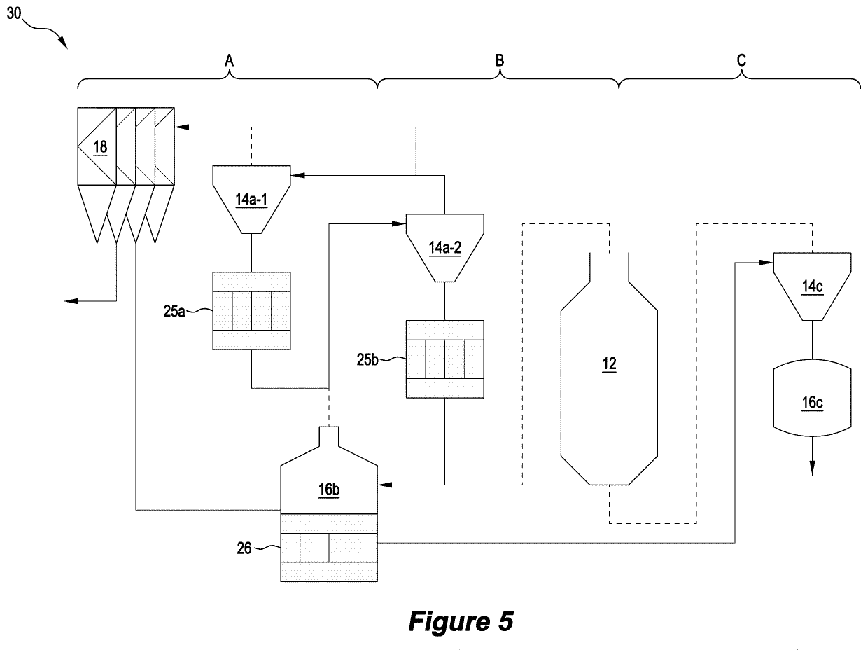

FIGS. 4 and 5 show two other embodiments of a calcination plant 30 in accordance with the invention.

The FIGS. 4 and 5 embodiments take advantage of the following points.
35% of the energy that is required to calcine aluminium trihydrate into alumina can be absorbed below 400° C., suitably around 350° C.—as noted above in relation to the FIG. 3 embodiment.
80% of the energy that is required to calcine aluminium trihydrate into alumina can be absorbed below 800° C., suitably around 600° C.

It is noted that the last part of the energy that is required to complete calcination is required primarily to obtain desirable alumina surface properties. This energy is absorbed above 760° C. The temperature is inversely proportional to the residence time at said temperature.

The calcination plant 30 in both embodiments in FIGS. 4 and 5 differs from the plant 20 in FIG. 3 in that a 2^{nd} fluidised bed reactor 25b is positioned between the cyclone separator 14b and the furnace 12. The 2^{nd} fluidized bed reactor 25b typically operates at around 600V. The 2^{nd} fluidized bed reactor 25b is electrically-heated.

In the 2^{nd} fluidised bed reactor 25b in both embodiments in FIGS. 4 and 5, aluminium trihydrate particles from cyclone separator 14a-2 are heated to a temperature of around 700° C. This results in further calcining aluminium trihydrate to at least aluminum oxyhydroxide (γ-AlOOH or AlO(OH)) and to alumina (Al₂O₃).

As such, heating the aluminium trihydrate particles in the electrically-heated 2^{nd} fluidised bed reactor 25b can provide another 40-60% of the energy that is required to calcine aluminium trihydrate into alumina.

The remaining approximately 10%-30% of the energy that is required to form alumina is provided by the furnace 12 shown in FIGS. 4 and 5.

As such, the incorporation of the electrically-heated 1^{st} and 2^{nd} fluidised bed reactors 25a, 25b in the embodiments in FIGS. 4 and 5 improves the thermal efficiency of the calcination process by providing 70-90% of the energy required to calcine aluminium trihydrate at lower temperatures than in the conventional plant in FIGS. 1 and 2.

In addition, the fluidised bed reactors substitute 70-90% of the total energy derived from natural gas or other fossil fuels, with electrical energy that can be derived from renewable sources-which can result in a significant reduction in associated greenhouse gas emissions.

To maximize heat recovery and limit power consumption, the 1^{st} and 2^{nd} fluidised bed reactors 25a, 25b in FIGS. 4 and 5 may be arranged so that there is counter-current flow of the flue gas and aluminium trihydrate particles in the reactors.

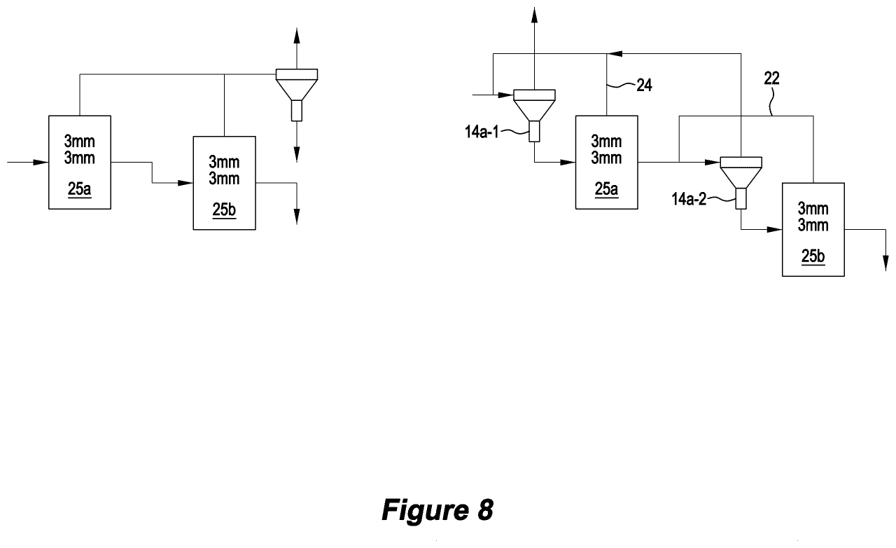

In one such arrangement shown in FIG. 8, flue gas exiting the fluidised bed reactor 25b in line 22 is directed into cyclone separator 14a-2 and flue gas exiting the fluidized bed reactor 25a in line 24 is directed into cyclone separator 14a-1. This flue gas flows counter-current to aluminium trihydrate particles through the fluidized bed reactors 25a, 25b.

Some of the gas fed into cyclone separator 14a-2 may be diverted into cyclone separator 14a-1 which itself may purge part of the flue gases fed into it into the environment.

The FIG. 5 embodiment shows additional heating devices that are not part of the FIG. 4 embodiment. The additional heating devices 26 are located within the holding vessel 16b to provide additional thermal energy to calcinate the aluminium trihydrate.

The applicant has carried out the following work in relation to the invention:
Proof of concept in laboratory—phase 1 (−35% use of natural gas derived energy)—Gibbsite to boehmite conversion in a reactor with fluidised bed and 240V electrical elements.
Engineering design for a full scale reactor of phase 1 (−35% use of natural gas derived energy)
Proof of concept in laboratory—phase 2 (−80% use of natural gas derived energy)—Gibbsite to alumina conversion in a series of 2 reactors with fluidised bed and electrical elements.

Table 1 below provides a summary of the results of the proof of concept in laboratory pilot—phase 2.

The Table shows that LOI below 5% was only obtained when the 2^{nd} reactor temperature was above 500° C., indicating that the 2 reactor set up works.

TABLE 1

| Reactor 1 | Reactor 2 | |
|---|---|---|
| temperature (° C.) | temperature (° C.) | LOI (%) |
| 150 | 351 | 12.25% |
| 150 | 354 | 12.23% |
| 150 | 354 | 12.0% |
| 150 | 355 | 12.3% |
| 150 | 355 | 12.4% |
| 150 | 338 | 12.9% |
| 150 | 338 | 13.3% |
| 285 | 606 | 4.3% |
| 285 | 605 | 4.2% |

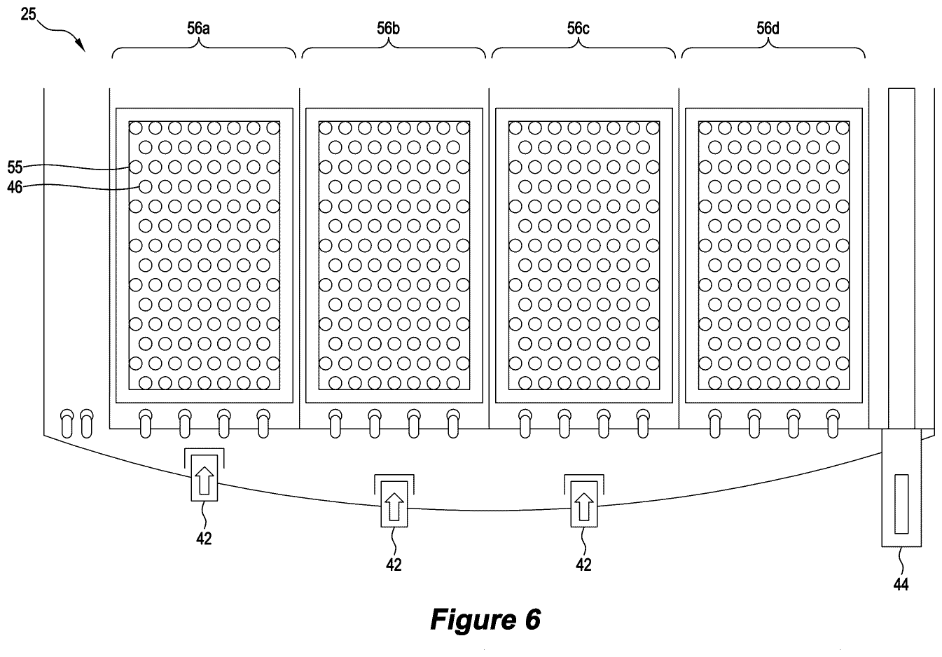

FIG. 6 shows a horizontal sectional view of a bottom half of an embodiment of a fluidised bed reactor 25 for use in embodiments of a calcination plant in accordance with the invention.

The fluidised bed reactor 25 can be used as one or both of the 1^{st} and 2^{nd} fluidised bed reactors 25a, 25b as previously described with reference to FIGS. 3-5.

As viewed in FIG. 6, the fluidised bed reactor 25 comprises a vertically oriented vessel 40 with a plurality of inlets 42, a lower outlet 44 and a plurality of electric heating devices 46 in the vessel 40.

In some embodiments, the vessel 40 has an outer diameter of about 3.6 m in embodiments where the fluidised bed reactor is circular in section.

It is noted that the invention extends to any suitable shape and size for the fluidised bed reactors, such as reactors that are rectangular in section.

As shown in FIG. 6, the fluidised bed reactor 25 comprises a plurality of cartridges 56a, 56b, 56c, 56d in the vessel 40, each cartridge having a plurality of electric heating devices 46, known as a bundle 55, attached thereto. Each cartridge is configured to be removeable from the fluidised bed reactor 25 and replaced with another cartridge. An advantage of this arrangement is that a plurality of electric heating devices 46 can be quickly replaced without having to overhaul the entire fluidised bed reactor 25. However, each electric heating device 46 in the bundle 55 may be wired individually to enable individual replacement of a single damaged electric heating device 46.

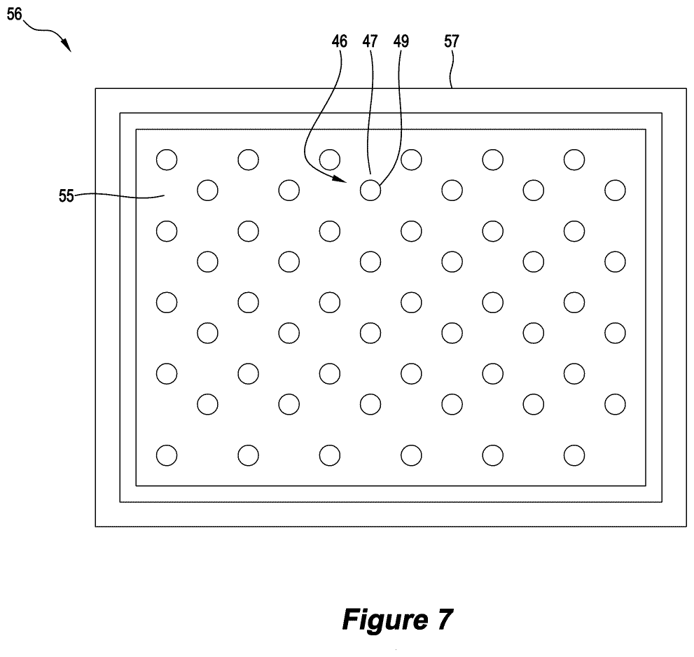

FIG. 7 shows a cartridge 56 (which is an example of cartridges 56a, 56b, 56c, 56d in FIG. 6) which comprises a frame 57 which holds the bundle 55 of electric heating devices 46. The frame 57 is slidable relative to a mounting point within the vessel 40 of the fluidised bed reactor 25. In some embodiments, the 57 frame comprises 57 wheels or bearings to assist moving the frame 57 into and out of position in the fluidised bed reactor 25.

Each electric heating device 46 comprises a metal tube 47 which houses an electric heating element 49 as wells other electronic componentry, such as a thermocouple, an active terminal, a neutral terminal and a ceramic spacer.

It is generally preferred to have small electric heating devices 46 with a low energy input per heating device 46 rather than larger electric heating devices 46 with a higher energy input per heating device 46. In some embodiments, there are between 500 and 800 electric heating devices per fluidised bed reactor.

Each electric heating device 46 is supported at two points relative to the frame 57, i.e., in a middle section of the electric heating device 46 and at an end of the electric heating device 46. Supporting the electric heating devices 46 in this manner limits sag and vibration of the electric heating devices 46.

Locating the electric heating element 49 inside the metal tube 47 provides a number of advantages. Firstly, it protects the heating element 49 from the environment within the fluidised bed reactor 25. Second, it makes it easier for the electric heating element 49 to be handled and replaced. Thirdly, it improves the efficiency of heat transfer between the electric heating element 49 and aluminium trihydrate particles, because the metal tube 47 absorbs radiant heat produced by the electric heating element 49 which would otherwise be dissipated by the air in the fluidised bed reactor 25.

In summary, the electric heating device 46 provide the following advantages:
1. The metal tube 47 protects the heating elements 49 from external elements such as steam and moisture.
2. The metal tube 47 is stiffer than the heating elements 49 and can therefore be more easily supported inside the vessel 40 than the heating element 49 on its own.
3. The metal tube 47 can be more easily disconnected and removed as a unit, providing a more convenient means of replacement.

The metal tube 47 has an outer diameter (OD) of between 40 mm and 70 mm, suitably 44.2 mm. In some embodiments, the metal tube contains between three and six electric heating elements 49.

For full phase angle control of three phase power, a star connection for the active terminal (not shown) is preferred over a delta connection because a star connection is more robust than a delta connection. In delta connections, unlike in a star connection, if one heating element 49 in the group fails it can cause the other heating elements 49 in the group to overheat and thus fail quicker.

In an example of three heating elements 49, each heating element 49 is connected to the common neutral terminal with opposite end of each element connected to the active terminal. An earth cable (not shown) is connected to the terminal. In another example, if six heating elements 49 are employed, two heating elements 49 are paired in parallel to the one active terminal.

The current draw for the heating element 49, in amps, is calculated by dividing the power required, in Watts, by the Voltage. Then for each individual active terminal the Amps is divided by the number of heating elements 49. For example, for a 30 kW heating element 49, the Amps required per active connection;
=30000 (W)÷240 (V)=125 Amps per heating element 49
=125 (Amps)÷3=42 Amps per active connection

In an example with a fluidised bed reactor having eight cartridges, each cartridge containing sixty-six 35 kW electric heating devices 46, i.e., a total of 528 electric heating devices 46, the total power input is 18 MW.

In use, the heat generated by the electric heating elements 49 is transferred to the metal tube 47 which is cooled by heating the aluminium trihydrate. As such, for a set amperage supplied to the electric heating element 49 the temperature of the metal tube 47 is set by the heat transfer rate to the aluminium trihydrate. In use, the temperature of the electric heating elements 49 rises until it is supplying the energy to the metal tube 47 set by the amperage. The maximum temperature of the electric heating elements 49 can be set and controlled to by varying the amperage, or the hydrate temperature in the reactor can be used to control the amperage.

For example, if an electric heating element 49 is supplied with a total of 125 amps, i.e., 30 kW on a 240V circuit, the temperature of the electric heating element 49 increases until the 30 kW of energy is able to be taken away by the hydrate. Because the energy to break off the molecules of water is over 1.6 times that required to boil water, the heat transfer rate into the hydrate is very high once the hydrate reaches around 300° C. To achieve this temperature in the aluminium trihydrate, the metal tube 47 temperatures will necessarily be higher than in the aluminium trihydrate.

The thermocouple provides over temperature protection.

The ceramic spacers are made from a high alumina ceramic, cast to the dimensions required.

Many modifications may be made to the embodiments of the present invention described above without departing from the spirit and scope of the invention.

1. A process for calcining aluminium trihydrate (Al₂O₃·3H₂O) to form alumina (Al₂O₃) comprising:
(a) supplying aluminium trihydrate particles to an electrically heated 1^{st} reactor and heating aluminium trihydrate particles to temperatures up to at least 280° C. and no greater than 400° C. and calcining at least a major part of the aluminium trihydrate to aluminum oxyhydroxide (γ-AlOOH or AlO(OH)) in the 1^{st} reactor; and
(b) supplying aluminum oxyhydroxide particles from the 1^{st} reactor to a 2^{nd} reactor and heating aluminum oxyhydroxide particles and calcining aluminum oxyhydroxide to alumina.

2. The process defined in claim 1 comprising heating aluminium trihydrate particles to temperatures up to at least 350° C. in the 1^{st} reactor.

3. The process defined in claim 1 comprising heating aluminium trihydrate particles to temperatures between 280° C. and 400° C. in the 1^{st} reactor.

4. The process defined in claim 1 comprising providing at least 35% of the energy that is required to calcine aluminium trihydrate into alumina to the 1^{st} reactor at temperatures of up to 350° C.

5. The process defined in claim 1 comprising providing at least 80% of the energy that is required to calcine aluminium trihydrate into alumina to the 1^{st} reactor at temperatures up to 350° C. and to the 2^{nd} reactor at temperatures up to 500° C.-800° C.

6. The process defined in claim 1 comprising heating aluminum oxyhydroxide particles at temperatures up to 720° C. in the 2^{nd} reactor and calcining aluminum oxyhydroxide in the 2^{nd} reactor.

7. (canceled)

8. The process defined in claim 1 comprising providing 20-50% of the energy that is required to calcine aluminium trihydrate into alumina at temperatures up to 350° C. in the 1^{st} reactor.

9. The process defined in claim 8 comprising providing 40-90% of the energy that is required to calcine aluminium trihydrate into alumina at temperatures up to 760° C. in the 2^{nd} reactor.

10. The process defined in claim 9 comprising providing the remainder of the energy that is required to calcine aluminium trihydrate into alumina, typically to obtain a target product quality, such as desirable alumina surface properties, in a 3^{rd} reactor after the 2^{nd} reactor.

11. The process defined in claim 10 comprising heating aluminium trihydrate particles to temperatures up to 1000° C. in the 3^{rd} reactor.

12. The process defined in claim 1 wherein either or both the 1^{st} and second reactors is a fluidised bed reactor.

13. The process defined in claim 1 wherein the 1^{st} and 2^{nd} reactors are arranged in a counter-current configuration.

14. (canceled)

15. The process defined in claim 1 wherein the 1^{st} and 2^{nd} reactors are configured to facilitate direct contact between aluminium trihydrate particles supplied to the reactors and electrical heating elements in the reactors.

16. The process defined in claim 1 comprising heating aluminum oxyhydroxide particles from the 1^{st} reactor and supplying heated aluminum oxyhydroxide particles to the 2^{nd} reactor and heating aluminum oxyhydroxide particles and calcining aluminum oxyhydroxide in the 2^{nd} reactor.

17. The process defined in claim 1 comprising drying feed aluminium trihydrate particles by heat transfer from hot offgas from the process, separating dried feed aluminium trihydrate particles from the offgas stream, and supplying the dried feed aluminium trihydrate particles to the 1^{st} reactor.

18. An apparatus for calcining aluminium hydroxide (Al₂O₃·3H₂O) to form alumina (Al₂O₃), the apparatus comprising:
(a) an electrically heated 1^{st} reactor that is configured to heat aluminium trihydrate particles to temperatures up to at least 280° C. and no greater than 400° C. and calcining at least a major part of the aluminium trihydrate to aluminum oxyhydroxide (γ-AlOOH or AlO(OH)) in the 1^{st} reactor; and
(b) a 2^{nd} reactor for heating and calcining aluminum oxyhydroxide particles from the 1^{st} reactor to alumina.

19. The apparatus defined in claim 18 wherein the 1^{st} reactor is a 1^{st} fluidised bed reactor that has electrical heating elements in the reactor.

20. The apparatus defined in claim 19 wherein electrical heating elements of the 1^{st} fluidised reactor comprise (a) metal tubes, and (b) electric heating elements within the tubes.

21. The apparatus defined claim 18 wherein the 2^{nd} reactor is a 2^{nd} fluidised bed reactor that has electrical heating elements within the reactor.

22. The apparatus defined in claim 21 wherein electrical heating elements of the 2^{nd} fluidised bed reactor comprise (a) metal tubes, and (b) electric heating elements within the tubes.
